(19) United States
(12) Patent Application Publication
(10) Pub. No.: US 2026/0080330 A1
(43) Pub. Date: Mar. 19, 2026

(54) SYSTEMS AND METHODS FOR MANAGING PHYSICAL ASSETS ACROSS TERRITORIAL BOUNDARIES

(71) Applicant: Biosphere Aerospace, LLC, Carpinteria, CA (US)

(72) Inventor: Elie Helou, JR., Santa Barbara, CA (US)

(73) Assignee: Biosphere Aerospace, LLC, Carpinteria, CA (US)

(21) Appl. No.: 19/192,160

(22) Filed: Apr. 28, 2025

Related U.S. Application Data
(63) Continuation of application No. 16/932,536, filed on Jul. 17, 2020, now abandoned.
(60) Provisional application No. 62/875,084, filed on Jul. 17, 2019.

(51) Int. Cl. G06Q 10/0631; G06Q 20/14; G06Q 50/26; G06Q 50/40

(52) U.S. Cl. CPC G06Q 10/06315; G06Q 10/06316; G06Q 20/145; G06Q 50/26; G06Q 50/40

(57) ABSTRACT

Systems and methods are provided for the transfer of legal control of a physical asset when the physical asset is transported across a territorial boundary. Such systems and methods facilitate the transfer of assets within a network between network participants associated with and having control over territories when an asset crosses a territorial boundary. Such a transfer allows for efficient and equitable distribution of costs, revenues, and other elements associated with movable assets among network participants in a region of control.

### CROSS-REFERENCE TO RELATED APPLICATION

This application is a continuation of U.S. patent application Ser. No. 16/932,536, filed on Jul. 17, 2020, which claims priority to U.S. Provisional Application No. 62/875,084, filed on Jul. 17, 2019, which is hereby incorporated herein by reference in its entirety.

### TECHNICAL FIELD

The disclosed technology relates generally to logistics in autonomous, partially-autonomous, and manned transportation systems. More specifically, some embodiments relate to systems and methods which manage the transfer of legal control of a movable entity when the movable entity is transported across a territorial boundary.

### DESCRIPTION OF THE RELATED ART

An existing system governed by the Universal Postal Union (“UPU”) uses a fee-distribution method based on the weight and number of parcels received. Participants include various postal organizations in the world that transport letters, post, and packages between different countries and territories. The fee that a consumer pays, e.g., by purchasing a stamp, is distributed among many entities, which together transport a piece of mail from one territory to another. The fee is based on the weight or amount of mail.

In another existing system, a company may own various assets, such as trucks, and dealers may receive a percentage of the revenues raised by assets with which the dealers were involved, with the percentage distributed based on an agreement.

In another existing system, a company provides a service leveraging physical assets owned by contractors. A customer may pay a fee on a per-use basis to the corporation, which the corporation then distributes to the asset holders based on an agreement.

### BRIEF SUMMARY OF EMBODIMENTS

Though the existing systems and methods may improve the quality of business services offered or distribute costs, they do not provide for a transfer of payment responsibility, physical control, or ownership of physical assets upon the crossing of a boundary separating one territory from another. Embodiments of the presently disclosed methods and systems are capable of transferring control and/or responsibility for a physical asset upon the crossing of a boundary, and may have several advantages. Though logistics assets often travel between territories such as towns, cities, and even countries, they are usually owned or operated by a single entity. Embodiments disclosed herein that allow ownership and/or responsibility to transfer upon the crossing of a physical or virtual boundary may promote greater efficiency. For instance, such a model would be advantageous in allowing companies to meet the political realities involved when a drone flies from one country to another country. In embodiments of the present technology, control of the drone transfers to an entity in the country that has jurisdiction over the airspace in which the drone flies.

Methods and systems adapted to manage control of physical assets across territorial boundaries, especially given improvements in autonomous systems, are desirable. Such methods and systems may be useful for movable assets that are fully autonomous, partially autonomous, or manned by human beings. Methods and systems that account for and respond to changes in jurisdiction and political realities associated with transportation through different territorial regions may confer significant advantages and benefits. Specifically, a method or system capable of effectuating the transfer of control of a physical asset based on information received regarding the asset's positioning, including whether the asset has crossed a physical or virtual boundary, would allow companies, governments, organizations, individuals, and others to efficiently share in the costs and revenues associated with the asset. Such systems may also alleviate political tensions and transaction costs by automatically transferring control of assets upon entrance into a new country or territory.

The technology disclosed herein may relate to many types of movable assets and may be effective on both a global and a local scale, and potentially effective in relation to transportation of assets in space as well. For instance, on a global scale, an embodiment of the present technology may allow for ownership and/or control of a drone and/or responsibility for the drone to pass from one country to another, automatically, upon the drone's entrance into a particular country's airspace.

In another embodiment, the present technology may allow for a network, such as an intra-city bus system, to distribute fees among the member cities in an efficient way. For instance, in existing systems, only one city may pay fees associated with the bus, such as wear-and-tear costs, even though several cities benefit from the bus route. The present technology may allow for all member cities associated with an intra-city bus system to share proportionally in infrastructure maintenance costs depending on the amount of time a given bus spends in each city's area. Other physical assets, such as trucks, trains, and ships, likewise trigger similar associated costs as a result of their transit through the physical world. A system such as the intra-city bus system discussed above may, in addition to allowing the member cities to share the costs associated with a given bus, also permit the member cities to proportionally share in the revenue associated with a given bus.

In some cases, the physical asset could be a unique, self-contained program that would be transferred to one entity and then returned when done. Such a physical asset, although electronic, would exist as a unique, self-contained program, be loaned when needed, and be returned when the work is completed. Examples include artificial intelligence (AI) systems that can be transferred over an Internet connection, used, and then returned when finished. No copies are kept in the territory that finished using the program and then returned the program or AI. In one embodiment, the physical asset is a sub-routine or part of a self-contained program or AI system.

An approach that can provide a more equitable revenue-sharing scheme to the entities it impacts can have beneficial outcomes, such as a quicker adaptation cycle and better use of the moving assets, and can lower entry barriers to expensive assets by allowing the sharing of costs among multiple participants. This type of approach can also provide the right incentives to the right entities to maximize profits and efficiencies. Rarely is a foreign entity able to provide the response and have the ready knowledge to deal in territories with which it is not familiar. The technologies and approaches described herein may allow a transportation technology or other movable physical asset to penetrate more easily and be accepted.

One factor driving the need for a new approach is the continued need to reduce costs. With the advent of the instant gratification and convenience society, businesses involved in the delivery of goods have received continued pressure to reduce costs and to increase delivery speeds. Nowhere has that been more evident than in the world of e-commerce.

E-commerce has been a large driver of the need for shorter delivery times and for lower costs of goods delivery. To meet the demand for ever shorter delivery times, air transportation of goods has grown significantly. Air cargo costs, however, have continually been several orders of magnitude more expensive than the costs for cargo transported by ships, especially when the ships transport the cargo using intermodal containers. This cost barrier has resulted in mostly high-value goods being transported by air to meet the shipper's requirement to make a profit. In some cases, contractual time delivery requirements have resulted in companies being forced to ship goods by air at a loss just to meet delivery requirements and avoid cancellation or late fees.

Embodiments of the present technology disclose methods and systems for managing physical assets across territorial boundaries that help to alleviate existing cost concerns. Several embodiments are discussed briefly below, and in greater detail in the detailed description following. These embodiments are examples only. The technology is not limited to these embodiments, and those having skill in the art may readily appreciate additional embodiments.

Embodiments of the present technology disclose systems and methods for managing physical boundaries within a network, pursuant to a set of rules defined by a network controller. The set of rules governs the transfer of control of physical assets and/or physical control of the assets in the network between network participants as the assets pass between territories within the network, the network participants being associated with the territories.

Embodiments of the present technology disclose systems and methods for managing physical assets across territorial boundaries that further utilize sub-territories within the network.

Embodiments of the present technology disclose a method or system for managing physical assets across territorial boundaries, the method or system including a network controller region database. The database collects and stores information related to the assets, such as information about wear-and-tear and location, which may then be used by the network controller to develop and update a set of rules governing the proration of costs and revenues associated with the assets as well as control over the assets among network participants.

Embodiments of the present technology disclose a system and method for managing physical assets across territorial boundaries employing a pay-per-use model. The network controller may develop and update a set of rules governing the network participants and assets such that the network participants share in the costs and revenues associated with the assets depending on their use of those assets within their respective territories. In some cases, the functions of the network controller may be decided by the group of network participants themselves, obviating the need for a separate network controller.

Embodiments of the present technology disclose a system and method for managing physical assets across territorial boundaries, wherein assets are provided to a network for a period of time but are owned by another entity. In one case, the assets may be owned by an entity that is not the network controller or one of the network participants. In that case, the network controller may have the controlling rights to the assets and can decide how the assets are used. An example includes aircraft leasing companies that loan their aircraft to an airline, but the aircraft are owned by a third party.

Embodiments of the present technology disclose a system and method for managing physical assets between two territories. Specifically, a method may allow for control of a physical asset to pass from one network participant associated with a first territory to a second network participant associated with a second territory. The network participants, pursuant to a set of rules developed and updated by the network controller, may share proportionally in the costs and revenues associated with the asset based on the respective time the asset is located in the first and second territories. For instance, a first network participant may be responsible for a cost proportional to a first amount of time that an asset spends in the first territory. A second network participant may be responsible for a cost proportional to a second amount of time that the asset spends in the second territory. In some cases, an adjustment would be made if the asset is in a territory but not moving or being used. Such an adjustment may include reduced costs and/or fee sharing as might be appropriate.

According to various embodiments of the disclosed technology, there is provided a method for managing physical assets across a region of control. The method may comprise the steps of defining, by a network controller, a plurality of territories, each of the plurality of territories having a boundary; defining, by the network controller, a set of rules across a region of control, the region of control comprising the plurality of territories; associating, by the network controller, each of a plurality of network participants with one or more of the plurality of territories; implementing, by a first one of the plurality of network participants operating under an agreement with the network controller, at least a portion of the set of rules within a first one of the plurality of territories, the first one of the plurality of network participants being associated with the first one of the plurality of territories; moving, under the ultimate control of the first one of the plurality of network participants, a physical asset within the first one of the plurality of territories, and then across the boundary of the first one of the plurality of territories into a second one of the plurality of territories; and transferring, by the first one of the plurality of network participants, ultimate control of the physical asset to a second one of the plurality of network participants when the physical asset moves into the second one of the plurality of territories, the second one of the plurality of network participants being associated with the second one of the plurality of territories.

In various embodiments, the boundaries of the plurality of territories are physical or virtual boundaries. In various embodiments, the territories may be geographic territories or territories in space. The network controller may define a network that encompasses a spatial region of operation with specific assets contributed to the network.

According to an embodiment of the disclosed technology, the plurality of territories comprises one or more of the following: cities, counties, states, countries, economic exclusive zones, terrestrial regions, and extraterrestrial regions.

According to an embodiment of the disclosed technology, the set of rules comprises one or more of the following: communication protocols, fee protocols, control protocols, and maintenance protocols.

According to an embodiment of the disclosed technology, the set of rules comprises a protocol for sharing of costs and revenues between the plurality of network participants based upon amounts of time during which the physical asset is located within each of the plurality of territories. The set of rules may be updated from time to time by the network controller.

According to an embodiment of the disclosed technology, the set of rules comprises a protocol for moving the physical asset across the territorial boundary of one of the physicality of geographic territories if the physical asset is idle for a predetermined period of time. In another embodiment, the set of rules comprises a protocol for moving the physical asset across the territorial boundary of one of the physicality of geographic territories if a profitability threshold is not met.

According to an embodiment of the disclosed technology, the physical asset is not owned by the network controller.

According to an embodiment of the disclosed technology, in the step of associating each of the plurality of network participants with one or more of the plurality of territories, each network participant of the plurality of network participants is associated with only one of the plurality of territories.

According to an embodiment of the disclosed technology, the physical asset is selected from the group consisting of: aircraft, busses, trucks, drones, firetrucks, police cruisers, ships, snowplows, and trains.

According to an embodiment of the disclosed technology, the physical asset is fully or partially autonomous. In another embodiment, the physical asset is manually controlled.

According to an embodiment of the disclosed technology, the step of transferring ultimate control of the physical asset comprises transferring full or partial ownership of the physical asset.

According to an embodiment of the disclosed technology, the step of transferring ultimate control of the physical asset comprises one or more of the following: transferring a lease for the physical asset, transferring a pay-per-use contract for the physical asset, transferring payment responsibility for the physical asset, and transferring revenue-sharing payments. In various embodiments, the pay-per-use contract may cover one or more of the following: insurance costs, maintenance costs, repair costs, and wear-and-tear.

According to an embodiment of the disclosed technology, the method further comprises the step of distributing revenues or fees for use of the physical asset between the first network participant and the second network participant pursuant to the set of rules. In various embodiments, the step of distributing fees for use of the physical asset may take into account costs for one or more of the following: fuel use, insurance for the physical asset, labor needed to operate the physical asset, loan costs for the physical asset, maintenance of the physical asset, and wear and tear of the physical asset.

According to an embodiment of the disclosed technology, the method further comprises the step of prorating fees for use of the physical asset between the first network participant and the second network participant according to the set of rules. The fees may be prorated based upon a first time period that the physical asset is within the first one of the plurality of territories and a second time period that the physical asset is within the second one of the plurality of territories. The set of rules may be periodically updated by the network controller.

According to an embodiment of the disclosed technology, the method further comprises the steps of subdividing, by the first one of the plurality of network participants, the first one of the plurality of territories into a plurality of sub-territories, each of the plurality of sub-territories having a territorial sub-boundary; and associating, by the first one of the plurality of network participants, each of a plurality of network sub-participants with one or more of the plurality of sub-territories.

According to an embodiment of the disclosed technology, the method further comprises the steps of moving, under the ultimate control of the second one of the plurality of network participants, the physical asset within the second one of the plurality of territories, and then back across the territorial boundary of the first one of the plurality of territories; and transferring, by the second one of the plurality of network participants, ultimate control of the physical asset back to the first one of the plurality of network participants when the physical asset moves into the first one of the plurality of territories.

According to various embodiments of the disclosed technology, there is also provided a method for managing physical assets across territorial boundaries. The method comprises the steps of implementing, by a first one of a plurality of network participants operating under an agreement with a network controller, at least a portion of a set of rules within a first one of a plurality of territories defined by the network controller, the first one of the plurality of network participants being associated with the first one of the plurality of territories; moving, under the ultimate control of the first one of the plurality of network participants, a physical asset within the first one of the plurality of territories, and then across a boundary of the first one of the plurality of territories into a second one of the plurality of territories; and transferring, by the first one of the plurality of network participants, ultimate control of the physical asset to a second one of the plurality of network participants when the physical asset moves into the second one of the plurality of territories, the second one of the plurality of network participants being associated with the second one of the plurality of territories.

According to various embodiments of the disclosed technology, there is also provided a system for managing physical assets across territorial boundaries. The system comprises a physical asset configured to move within a region of control between a plurality of territories, each of the plurality of territories having a boundary; and a plurality of network participant modules, each associated with one or more of the plurality of territories. The physical asset may be in operative communication with a first one of the plurality of network participant modules that is associated with the territory in which the physical asset is located. Ultimate control of the physical asset may pass from the first one of the plurality of network participant modules to a second one of the plurality of network participant modules pursuant to a set of rules for the system defined by a network controller when the physical asset crosses the boundary of the territory associated with the second one of the plurality of network participant modules.

According to an embodiment of the disclosed technology, the physical asset is in operative communication with the second one of the plurality of network participant modules, and no longer in operative communication with the first one of the plurality of network participant modules, after ultimate control of the physical asset passes from the first one of the plurality of network participant modules to the second one of the plurality of network participant modules pursuant to the set of rules for the system defined by the network controller.

According to an embodiment of the disclosed technology, the physical asset comprises a positioning system; and a transceiver operatively connected to the positioning system. The transceiver may be configured to be in operative communication with the first one of the plurality of network participant modules when the physical asset is in the territory associated with the first one of the plurality of network participant modules. The transceiver may be configured to be in operative communication with the second one of the plurality of network participant modules when the physical asset is in the territory associated with the second one of the plurality of network participant modules.

According to various embodiments of the disclosed technology, there is also provided a system for managing physical assets across territorial boundaries. The system comprises a network controller module configured to define a set of rules for the system across a geographic region of control, the geographic region of control comprising a plurality of geographic territories, each of the plurality of geographic territories having a territorial boundary; a plurality of network participant modules, each operatively connected to the network controller module and configured to implement at least a portion of the set of rules for the system within an associated one or more of the plurality of geographic territories; and a physical asset configured to move between the plurality of geographic territories and ultimately controlled by a first one of the plurality of network participant modules, the first one of the plurality of network participant modules being associated with the geographic territory in which the physical asset is located. Ultimate control of the physical asset may pass from the first one of the plurality of network participant modules to a second one of the plurality of network participant modules when the physical asset crosses the territorial boundary of the geographic territory associated with the second one of the plurality of network participant modules.

According to various embodiments of the disclosed technology, there is also provided a system for managing physical assets across territorial boundaries. The system comprises a physical asset configured to move within a geographic region of control between a plurality of geographic territories, each of the plurality of geographic territories having a territorial boundary and associated with one of a plurality of network participants; and a network controller module configured to define a set of rules for the system across the geographic region of control and in operative communication with the physical asset. Ultimate control of the physical asset may pass from a first network participant in the plurality of network participants to a second network participant in the plurality of network participants pursuant to the set of rules for the system when the physical asset crosses a territorial boundary.

Each feature or concept outlined above is independent, and can be combined with the other features or concepts outlined above or with any other feature or concept disclosed in this application.

These and other embodiments are discussed in greater detail below.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof.

FIG. 1 is a flowchart of a method for managing physical assets across territorial boundaries, according to an embodiment of the present technology.

FIG. 2 illustrates an example of a network controller's region of control with multiple network participants and the territories they control, according to an embodiment of the present technology.

FIG. 3 illustrates an example of a network controller's region of control that contains standard network participants as well as a master network participant that can have multiple network participants within its territory of control, according to an embodiment of the present technology.

FIG. 4 illustrates an example of a hierarchical structure showing the network controller as the primary developer of the network's rules within a region of control, according to an embodiment of the present technology.

FIG. 5 illustrates an example of a region controlled by a network controller within which physical assets travel between territories, according to an embodiment of the present technology.

FIG. 6 illustrates an example of a flow diagram of a network controller region database which is continually updated with inputs and provides outputs based on real time updates of inputs, according to an embodiment of the present technology.

FIG. 7 illustrates an example of a network controller region database, for use in a system for managing physical assets across territorial boundaries, according to an embodiment of the present invention.

FIG. 8 illustrates a diagram showing an example of a system for managing physical assets across territorial boundaries, according to an embodiment of the present technology.

FIG. 9 illustrates a diagram showing an example of a physical asset, according to an embodiment of the present invention

FIG. 10 illustrates an example of a machine which may supply the hardware for the system for managing assets across territorial boundaries, according to an embodiment of the present technology, can be practiced.

The figures depict various embodiments of the disclosed technology for purposes of illustration only, wherein the figures use like reference numerals to identify like elements. The figures are not exhaustive and do not limit the disclosure or the disclosed embodiments to the precise form disclosed. One skilled in the art will readily recognize from the following discussion that alternative embodiments of the structures and methods illustrated in the figures can be employed without departing from the principles of the disclosed technology described herein.

### DETAILED DESCRIPTION

Various embodiments of the present disclosure provide for transfer of legal control of a physical asset when the physical asset crosses a territorial boundary. In one example embodiment, a method for transfer of legal control involves definition of a network, region of operation, and territories with defined boundaries by a network controller. A network controller may then, with network participants associated with the territories, define a set of rules which governs control, responsibility, and/or ownership of assets as they move between territories within the defined region of operation. In another embodiment, a system for managing physical assets may include physical assets configured to move between territories and network participant modules associated with territories, between which control of the physical asset may pass when the physical asset crosses a boundary separating territories. More details are described herein.

The embodiments of the present technology can be implemented in or by a system or technological environment. A computer system can constitute, for example, a server (or cloud) computing system and/or a client computing system in various embodiments. In some embodiments, the present technology can be implemented, in part or in whole, as software, hardware, or any combination thereof. In some implementations, one or more components, modules, functions, tasks, and/or operations can be carried out or performed by software routines, software processes, hardware, and/or any combination thereof. In some cases, the present technology can be, in part or in whole, implemented as software running on one or more networked computing devices or systems, such as on a server and/or a client computing device. As just one example, the present technology can be implemented as or within a dedicated application (e.g., app), a program, or an applet running on a user computing device or client computing system in networked communication with a server. It should be understood that many variations are possible.

It should be appreciated that many other features, applications, embodiments, and/or variations of the disclosed technology will be apparent from the detailed description and accompanying drawings. Additional and alternative implementations of the methods, systems, and non-transitory computer readable media described herein can be employed without departing from the principles of the disclosed technology.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Express or implied reference in this specification to an embodiment, version, example, instance of the present technology, or the like means that a particular feature, design, structure, method, process, or characteristic described in connection with the embodiment is included in at least one embodiment of the disclosure. The appearance or description of an embodiment in various places in the specification are not necessarily all referring to the same embodiment, nor are separate or alternative embodiments mutually exclusive of other embodiments. Moreover, whether or not there is express reference to an embodiment or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the present technology be limited not by this detailed description, but rather by any claims that issue on an application based hereon. Accordingly, the disclosure of the embodiments of the present technology is intended to be illustrative, but not limiting, of the scope of the present technology.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

### Example Embodiment of Method for Managing Physical Assets Across Territorial Boundaries

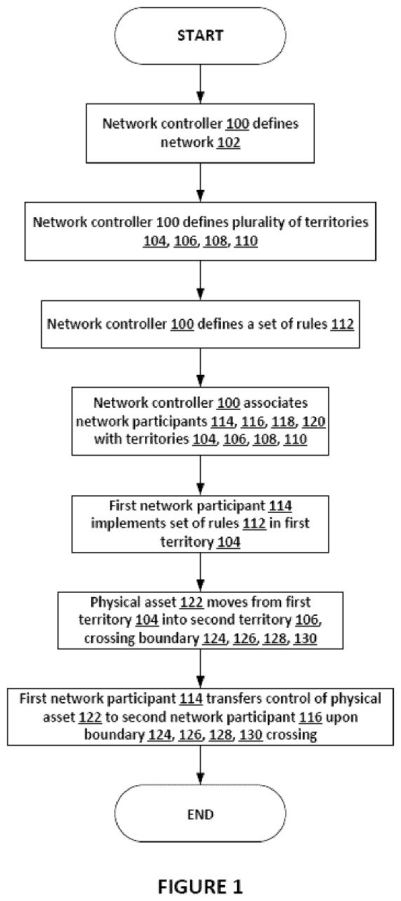

With reference now to FIG. 1 of the illustrative drawings, there is shown a flowchart explaining an example of a method for managing physical assets across space with defined boundaries. A Network Controller 100 may initiate a method for managing physical assets across space with defined boundaries by defining a Network 102. The Network 102 may include both a Network Controller 100 and Network Participants 114, 116, 118, 120. The Network Controller 100 may be made up of representatives of Network Participants 114, 116, 118, 120. The Network Controller 100 may also be a separate entity or a combination of entities. For example, the Network Controller 100 may be a governing body at the town, city, state, province, or country level. The Network Controller 100 may also be an organization comprised of a plurality of governing bodies, e.g., the governing bodies of several countries as proscribed by a treaty or other agreement. The Network Controller 100 may be an agency having oversight authority over a particular system, such as, for example, in the United States, the Department of Transportation or the Department of Homeland Security. The Network Controller 100 may also be a private sector company or a combination of private sector companies as proscribed by a contract or agreement. The Network Controller 100 may be a partnership of joint venture of two or more companies or an association of many companies or entities.

The Network Controller 100 may be responsible for defining and developing a Network 102. The Network Controller 100 may be responsible for continuously updating such a Network 102. The Network Controller 100 may be responsible for defining how an asset or group of assets contributed to the Network 102 may be used, treated, managed, operated, or otherwise controlled.

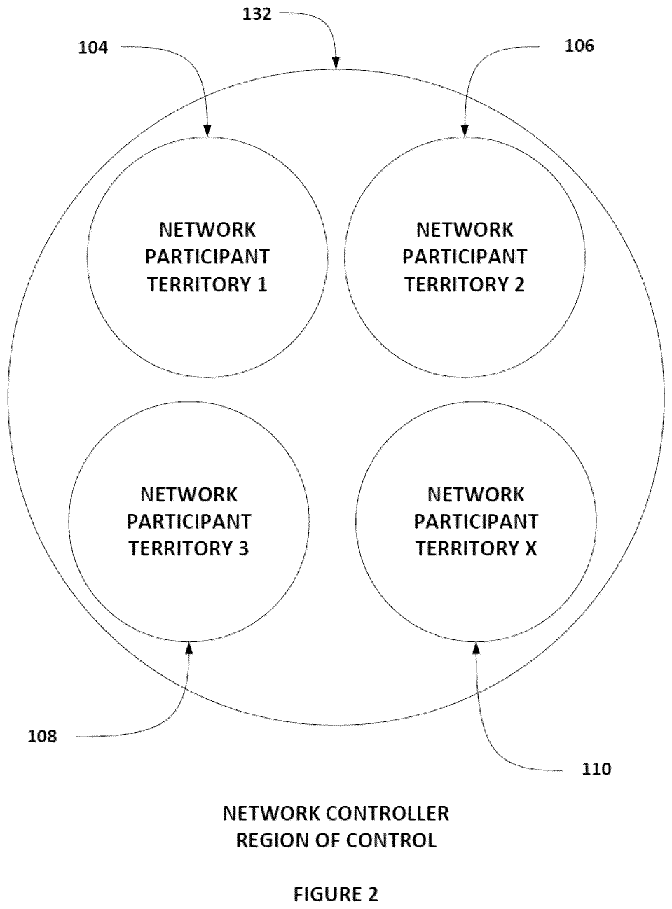

With reference now to FIG. 2 of the illustrative drawings, there is shown an example of Region of Control 132, as encompassed by the Network 102 defined by a Network Controller 100. The Network 102, as defined by the Network Controller 100 may encompass a Region of Control 132. The Region of Control 132 may be a geographical region. For instance, the Region of Control 132 may be a country, such as the United States. The Region of Control 132 may be any other geographical region such as a city, town, state, province, county, or other area, including a region in space or a planetary body. The Region of Control 132 may also be defined in a non-physical way. For instance, several entities, such as, for example, the governing bodies of several states, may participate in a joint agreement. In this case, the Region of Control 132 would include all parties to the agreement, whether or not they share geographical boundaries. For instance, both the states of California and Oregon may participate in a joint agreement, so the Region of Control 132 would include, in that instance, the entire geographic region encompassing California and Oregon. In another instance, California and New York may participate in a joint agreement, so the Region of Control 132, in that instance, would include both California and New York but not intermediate states geographically located between the two who are not parties to the agreement.

Referring to FIG. 1, the Network Controller 100 may define a plurality of territories 104, 106, 108, 110. Each of the plurality of territories may comprise a region in space. A territory may be a town, city, county, state, province, or country. A territory may also be a zone in which certain conditions are met or applicable, or over which certain entities are entitled to certain rights, regarding the right to use land in a particular way and/or ownership rights over natural resources. For instance, a territory may be a time zone or an economic exclusive zone. A territory may also comprise a region over which a certain governing body maintains jurisdiction or control. For instance, a territory may be a maritime territory or a territory on land. A territory may also be an extraterrestrial region. For instance, a territory in space may be any region now or in the future in which any entity maintains rights of exploration, use, or even ownership and control.

Each territory may have a boundary 124, 126, 128, 130. The Network Controller 100 may define such a boundary. A boundary may be a physical boundary. For example, a boundary may be a naturally occurring boundary such as a river or mountain range. A boundary may be a legal boundary. For instance, the boundary may be the border surrounding a state, country, or other jurisdiction. A boundary may also be defined based on the rights to which an entity within the region defined by boundary is entitled. For instance, a boundary may be one in which an entity possesses certain economic or legal rights, such as the right to use natural resources or the applicability of a tax or tariff.

The Network Controller 100 may define a set of rules 112 for the Network 102. The set of rules 112 may include communication protocols. For instance, the set of rules 112 may govern the format of data transmission and regulate the type and quantity of data transmitted between territories 104, 106, 108, 110. The rules may also govern error recovery methods, syntax, and any other relevant communication parameters. The set of rules 112 may also include fee protocols. For instance, a fee protocol may contain rules about which entity is responsible for particular fees under given circumstances, e.g., which entity bears the responsibility for taxes or tariffs. The fee protocol may also contain, for example, rules governing the distribution of fees among responsible entities. The fee protocol may contain any other relevant rules. The set of rules 112 may also include control or maintenance protocols. For instance, the set of rules may specify the conditions under which control, responsibility, or ownership of a movable physical asset passes between entities. As an example, under a defined control protocol, control over a drone may be defined to pass from one country to another when the drone enters into the airspace of the other country. As another example, under a defined maintenance protocol, responsibility over a city bus, including the responsibility to perform necessary maintenance and safety inspections, may be defined to pass from one city to another when the bus crosses a boundary separating the two cities.

In an embodiment of the present technology, a set of rules 112 may provide for equitable sharing of costs and revenues between one or more Network Participants 114, 116, 118, 120 under circumstances where certain conditions regarding the existence of assets in the territories 104, 106, 108, 110 associated with the Network Participants 114, 116, 118, 120 are met. For instance, if an asset exists within a territory 104, 106, 108, 110 during a set period of time, a Network Participant may, as proscribed by a set of rules 112 defined by the Network Controller 100, may be bound to undertake certain costs associated with the asset and may be entitled to receive certain revenues associated with the asset. As an example, both costs and revenues associated with an asset may be distributed among Network Participants 114, 116, 118, 120 proportionally depending upon the time the asset was maintained in any given territory 104, 106, 108, 110 associated with a Network Participant 114, 116, 118, 120.

Referring to FIG. 2, a Network Controller's 100 Region of Control 132 is shown. A set of rules 112, as defined by a Network Controller 100 may apply across a Region of Control 132. A Region of Control 132 may comprise a plurality of territories 104, 106, 108, 110, as defined by the Network Controller 100. The set of rules 112 may apply to all territories 104, 106, 108, 110 falling within the Region of Control 132.

In addition to defining a set of rules 112, boundaries 124, 126, 128, 130, and/or territories 104, 106, 108, 110, the Network Controller 100 may define any other parameters which are useful, necessary, or relevant to operation within the Network 100. For instance, the Network Controller 100 may act as a mediator to resolve potential disputes between Network Participants 114, 116, 118, 120.

Referring to FIG. 1, the Network Controller 100 may associate each of a plurality of Network Participants 114, 116, 118, 120 with one or more defined territories 104, 106, 108, 110. A Network Participant 114, 116, 118, 120 may be an entity, a company, an individual, or any combination of entities, companies, and individuals. A Network Participant 114, 116, 118, 120 may control a territory 104, 106, 108, 110. For instance, Network Participant 114, 116, 118, 120 may have the authority to promulgate and/or enforce legal rules within a territory 104, 106, 108, 110. A Network Participant 114, 116, 118, 120 may have the discretion to manage a particular type of resource within a territory 104, 106, 108, 110. For instance, a Network Participant 114, 116, 118, 120 may maintain control over setting bus routes and scheduling within a territory 104, 106, 108, 110. A Network Participant 114, 116, 118, 120 may have any other type of control over a territory, including control related to land use, transportation, natural resources, and other areas.

A Network Participant 114, 116, 118, 120 may have the authority or power to bind its associated territory to rules or other agreements. For instance, a Network Participant 114, 116, 118, 120 may agree, on behalf of its territory, to abide by an asset contract. For example, it may agree to share in the fees associated with use of a particular type of asset that may pass between territories 104, 106, 108, 110. A Network Participant 114, 116, 118, 120 may agree, on behalf of its territory, to abide by any other type of contract applicable to the Network 102, as defined by the Network Controller 100. For example, the Network Controller 100 may, pursuant to an agreement governing the Network Participant 114, 116, 118, 120 within a Region of Control 132, assume the role of a franchisor and designate Network Participants 114, 116, 118, 120 as franchisees. As franchisees, Network Participants 114, 116, 118, 120, may possess exclusive rights regarding the sale of goods or operation of services within their associated territories 104, 106, 108, 110. Network Participants 114, 116, 118, 120 may enter into any type of agreement with or as defined by a Network Controller 100.

A Network Participant 114, 116, 118, 120 may be associated with a territory 104, 106, 108, 110 in a one-to-one correspondence. In other words, a first Network Participant may be associated with exactly one first territory 104. A second Network Participant 116 may be associated with exactly one second territory 106. A third Network Participant 108 may be associated with exactly one third territory 118. Each subsequent Network Participant 120 may be associated with exactly one subsequent territory 110. Other combinations are also possible. For instance, a Network Participant 114, 116, 118, 120 may be associated with more than one territory 104, 106, 108, 110. Also, more than one Network Participants 114, 116, 118, 120 may be associated with and jointly share control over the same territory 104, 106, 108, 110.

Referring to FIG. 2, a Network Controller's 100 Region of Control 132 including a plurality of territories 104, 106, 108, 110 is shown. As illustrated by FIG. 1, the territories 104, 106, 108, 110 may each be associated with and controlled by Network Participants 114, 116, 118, 120.

A Region of Control 132 may include specific assets, which may be contributed to the Network 102. The Network 102 may control physical assets 122, as proscribed by a set of rules 112 defined by the Network Controller 100 in a number of ways. The Network 100 may control use of physical assets, responsibility for physical assets, ownership of physical assets, and/or any other aspect of control of physical assets. As an example, the Network 100 may control use of physical assets by providing rules governing which Network Participants 114, 116, 118, 120 may use a given physical asset 122 depending on time parameters, cost and revenue agreements, and/or the physical location of the physical asset 122 within a given territory 104, 106, 108, 110 associated with a Network Participant 114, 116, 118, 120. As another example, the Network may control responsibility for physical assets by providing rules governing which Network Participants 114, 116, 118, 120 are obligated to undertake costs relating to a physical asset 122, such as taxes, maintenance costs, insurance fees, and other costs, depending on time parameters, cost and revenue agreements, and/or the physical location of the physical asset 122 within a given territory 104, 106, 108, 110 associated with a Network Participant 114, 116, 118, 120. As another example, the Network 100 may control ownership of physical assets by providing rules governing which Network Participants 114, 116, 118, 120 own a physical asset 122 at any given time depending on time parameters, cost and revenue agreements, and/or the physical location of the physical asset 122 within a given territory 104, 106, 108, 110 associated with a Network Participant 114, 116, 118, 120.

Assignment of control of physical assets may involve full control over physical assets, for example, by dictating use, responsibility, and ownership of physical assets, as well as any other relevant parameters. Assignment of control may also be partial or temporary. For instance, use of a physical asset may be dictated by the Network Controller 100 when assigned to the Network 102 but ownership of the asset and/or responsibility for the asset may be proscribed independently. For instance, a separate party or parties may retain ownership of the asset or assets regardless of the rules concerning use and/or responsibility dictated by the Network Controller 100.

A transfer of control of an asset may include a transfer of rights or obligations associated with the asset, for instance, such as transferring a lease for a physical asset, transferring a pay per use contract for a physical asset, transferring payment responsibility for a physical asset, and/or transferring a revenue sharing payment pursuant to a set of rules defined by the network controller or any other agreement. Rights or obligations associated with an asset may be contractually based or may exist on other grounds.

Assets may include any movable units. As an example, physical assets may include vehicles such as busses, cars, trucks, aircraft, drones, ships, and trains. Physical assets may also include, for example, movable equipment such as snowplows, tractors, and other types of movable equipment. Physical assets may also include vehicles with specialized uses. For example, a firetruck, police cruiser, tank, or any other vehicle for use in law enforcement, defense, emergency services, or other specialized use may be a physical asset. Physical assets may also include self-contained programs and/or AI systems that are transmitted across physical or virtual boundaries.

Physical assets 122 may be fully or partially autonomous. For instance, a physical asset may be, for example, a drone, which may be fully autonomous. The drone may operated pursuant to a set of instructions, as defined by the Network Controller 100 and/or the Network Participants 114, 116, 118, 120, without the need for an operator or driver. Alternatively, a physical asset, for example, a drone, may be partially autonomous. It may in some instances operate autonomously but also may allow for control by a manual operator, either remote or on-board. Other physical assets contributed to the network may be manually controlled. For instance, the physical asset may be a truck, for example, which may be manually operated by a driver pursuant to rules proscribed for the Region of Control 132.

Referring to FIG. 1, a first Network Participant 114 may enter into an agreement with a Network Controller 100. Under the terms of such an agreement, a first Network Participant 114 may implement a set of rules 112, as defined by a Network Controller 100 within a first territory 104, with which a first Network Participant 114 is associated and has control over, of a plurality of territories within a Region of Control 132. A first Network Participant 114 may implement an entire set of rules 112 within its associated territory 104. A first Network Participant 104 may also implement only a portion of a set of rules 112 within its associated territory 104. Similarly, a second Network Participant 116, a third Network Participant 118, or any subsequent Network Participant 120 may enter into an agreement with the Network Controller 100 and implement, partially or fully, a set of rules 112, as defined by the Network Controller 100, within their respective territories 106, 108, 110.

A first Network Participant 114 may, pursuant to an agreement with and/or set of rules 112 defined by a Network Controller 100, have control over a physical asset 122 within its associated territory 104. A first Network Participant 114 may move a physical asset 122 within its control across a boundary 124 defined for the first Network Participant's 114 associated territory 104 and into a second territory 106 associated with a second Network Participant 116. Similarly, a second Network Participant 116, a third Network Participant 118, or any subsequent Network Participant 120 may have control over and move a physical asset 122 into any other territory 104, 106, 108, 110 within the Region of Control 132. Likewise, a second Network Participant 116 may, pursuant to an agreement with and/or set of rules 112 defined by a Network Controller 100 have control over a physical asset 122 within its territory 106. A Second Network Participant 116 may move a physical asset back across a boundary 126 defined for the second Network Participant's 116 associated territory 106 thus returning the physical asset 122 to a first Network Participant's 114 associated territory 104. Control over the asset, including but not limited to, use, responsibility and/or ownership of the asset may then, upon the boundary crossing, revert back to the first Network Participant 114, consistent with a set of rules 112 defined by the Network Controller 100.

A first Network Participant 114 may, pursuant to an agreement with and/or set of rules 112 defined by a Network Controller 100, transfer control of a physical asset 122 to a second Network Participant 116 when the physical asset crosses a boundary 124, 126, 128, 130 and moves into a second territory 106 associated with a second Network Participant 116. Similarly, a second Network Participant 116, a third Network Participant 118, or any subsequent Network Participant 120 may transfer control over physical asset 122 to any other Network Participant 114, 116, 118, 120 within the Network 102 when the asset crosses a boundary 124, 126, 128, 130 into any other territory 104, 106, 108, 110 within the Region of Control 132.

### Example Embodiment of Method for Managing Physical Assets Across Territorial Boundaries Utilizing Sub-Territories

In certain circumstances, it may desirable to subdivide a territory 104, 106, 108, 110 into multiple sub-territories under one master network participant. In such a configuration, a master network participant may assume responsibility for network participants within the master network participant's territory and ensure that those network participants abide by the set of rules 112 defined by the Network Controller 100.

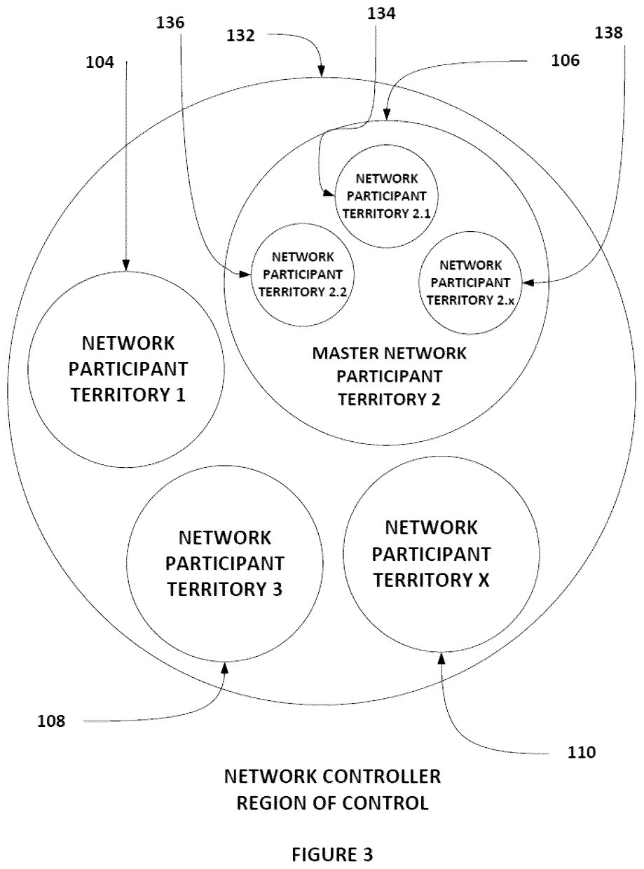

With reference now to FIG. 3 of the illustrative drawings, there is shown an example of an embodiment of the present technology wherein a Network Controller's 100 Region of Control 132 may contain one or more standard network participants, each with an associated network territory 104, 108, 110 as well as one or more master network participants, also with an associated territory 106. Within its associated territory of control 106, a master network participant may include multiple network participants, each with their own associated network territory 134, 136, 138. Territorial boundaries for each of these associated territories 134, 136, 138 may be defined.

### Additional Example Embodiment of Method or System for Managing Physical Assets Across Territorial Boundaries Including Network Controller Region Database

In an embodiment of the present technology, a Network Controller 100 may define both a set of territories 104, 106, 108, 110 as well as a set of assets for inclusion in the Network 102. For example, physical assets 122 may be cargo aircraft and containers. A two-tier system may be created wherein a Network is defined by the Network Controller and a set of rules defined by the Network Controlled controls the way assets are used and paid for and profit and costs are distributed within the Network among the Network Participants. The first tier may be a Network Controller, for example a company, that controls a region and creates a Network governing a defined set of movable physical assets. As discussed with respect to other embodiments, a Network Controller may establish maintenance protocols, control protocols, fee and rate protocols, and any other requirements including contracts, for Network Participants. Network Participants may make up the second tier of the Network and may operate within the network in the Network Controller's Region of Control.

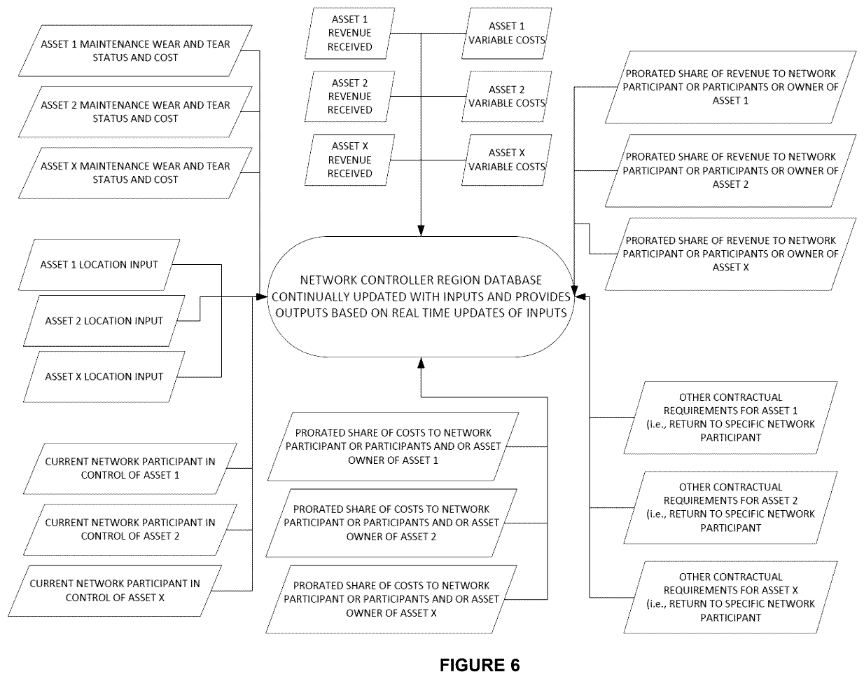

The Network Controller may develop and define a model for each physical asset 122 in the Network. The model relies on several categories of input information, which may be communicated to the Network Controller, as shown in FIG. 6. These categories include maintenance and wear-and-tear status and cost of assets, location input for assets, identification of a network participant in control of a given asset at a given time, revenue received based on a give asset, variable costs associated with a given asset, and other contractual requirements that may be associated with any given asset, such as, for example, a requirement that the asset be returned to a particular network participant. Based on this information, the Network Controller can develop, define, and update a model for the Network.

The model may provide for the proration and sharing of costs associated with assets among network participants. The model may also provide for the proration and sharing of revenues associated with assets among network participants. Such proration may be based upon any of the input categories above or other relevant information collected by the Network Controller pertaining to the assets. For example, the Network Controller's model may take into account whether an asset is leased or owned or has any other fees, revenue, and profit requirements. The model may also include anticipated wear and tear and/or maintenance costs, other expenses, such as, for example labor costs associated with the assets for a period of time, which may be defined on a per-second basis or any other agreed upon unit of time, and inclusive of any profits needed. The fees, revenues, profits, and expenses can be periodically updated by the network controller as the assets age or as other circumstances change.

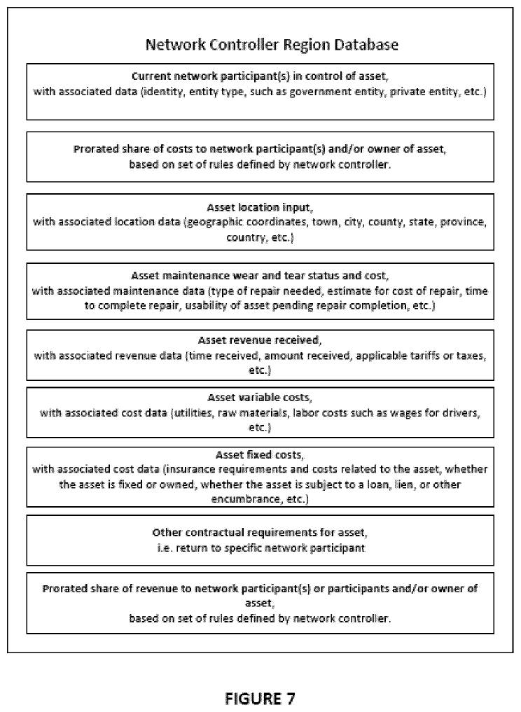

FIG. 7 shows an example of a Network Controller Region Database showing an example of the types of parameters and data that may be inputted to the Network Controller in order to determine a model governing use of assets in a Region of Control. For example, the Network Controller may collect and take into account data relating to the current network participant in control of an asset at a given time. The associated data may include the identity of the network participant as well as its entity status and associated tax information, for instance, and any fees or other parameters that may pertain to the current network participant. Data capturing the amount of time any given network participant is in control of any given asset may also be collected. The database may also store information related to the prorated share of costs of network participants or owners of assets. The proration may be determined by a set of rules as defined by a Network Controller. The proration may be based on the amount of time any given network participant retains control of an asset or any other parameter as agreed upon by the network.

The network controller may also collect data related to the physical location of a given asset at any given period in time. The data may include the geographical coordinates, spatial coordinates, or global positioning system (GPS) units for an asset. The data may also include the amount of time the asset was located at any given location. Additionally, the data may also include the town, city, county, state, province, country, or other territory or spatial location in which the asset was located for a given period of time.

The network controller may also collect data related to the cost of an asset. This data may include maintenance and wear-and-tear estimates, such as the type of repairs needed, estimated costs for repairs needed, estimated costs for complete times for repairs, information regarding whether the asset is usable pending repairs, as well as information about the age and quality of an asset which may be used to anticipate the type, cost, and length of likely repairs needed.

The network controller may also collect data related to revenue received for a given asset. This data may include the time revenues were received, where the asset was located when revenues were received, the amount of revenue received, the payee, and any applicable taxes or tariffs.

The network controller may also collect data related to both variable and fixed costs associated with a given asset. These costs may include utility costs, costs for raw materials, costs for fuel, labor costs, such as wages for drivers or operators, insurance costs associated with a given asset, costs associated with loans, liens, or other encumbrances on a given physical asset, information about the status of the asset, such as whether it is lease or owned, and thus information about its value in the future.

The network controller may also collect data related to other contractual requirements associated with any given asset, such as, for instance if the asset must be returned to a specific network participant. Alternatively, an asset may also be a free-floating asset or may be partially controlled by one or more Network Participants based on any contracts developed between the Network Participant or Network Participants and the Network Controller. For instance, if a route is no longer profitable, the Network Owner or Network Owners that have control of the asset and or Network Controller could then move the asset to a more profitable route or Territory that requires additional assets. Such moves may be temporary or permanent as negotiated between the affected Network Participants and Network Controller.

The network controller may store data related to the prorated share of revenue to network participants or asset owners based on a set of rules defined by the network controller. The proration may be determined by a set of rules as defined by a Network Controller. The proration may be based on the amount of time any given network participant retains control of an asset or any other parameter as agreed upon by the network.

In some cases, some or all of the data may have to be kept confidential as to a specific territory. For instance, a country might not want to have its internal logistics data shared or other sensitive data shared with other countries. In that case, the system can be configured to accommodate that requirement.

The Network Controller may be continuously responsible for updating the model based on the above discussed inputs of information, for instance based on wear and tear, asset age, increase maintenance and insurance requirements, and other associated costs. Therefore, the set of rules governing the network defined by the network controller may likewise be continuously updated by the network controller as determined by the model. The Network Controller may define and continually update requirements for each asset, for the territories, for the Network, and for the Network Participants.

### Additional Example Embodiment of Method for Managing Physical Assets Across Territorial Boundaries

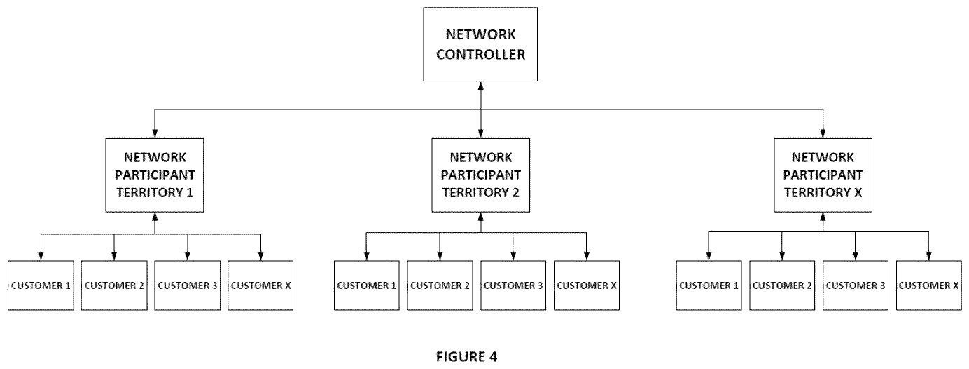

With reference now to FIG. 4 of the illustrative embodiments, there is shown an example of a hierarchical structure showing the Network Controller as the primary developer of the network's rules within a region of control, according to an embodiment of the present technology. As discussed with respect to other embodiments, Network Participants may join the Network and may agree to be bound by the set of rules defined and continually updated by the Network Controller. A plurality of customers may also exist within a territory associated with and controlled by a Network Participant within the Network Controller's Region of Control.

### Example Embodiment of Method for Managing Physical Assets Across Territorial Boundaries Employing a Pay Per Use Model

In one example embodiment, a Network Controller 100 may proscribe a set of rules 112 for physical assets 122 as well as territories 104, 106, 108, 110 associated with Network Participants 114, 116, 118, 120 in a Network 102 consistent with a pay-per-use model. In a pay-per-use model, a Network Participant 114, 116, 118, 120 may agree to pay a fee each time it uses a physical asset 122 within the Network 102. The obligation to pay the pay-per-use fee may transfer from, for example, a first Network Participant 114 associated with a first territory 104 within the Region of Control 132 to a second Network Participant 116 associated with a second territory 106 within the Region of Control 132 when the physical asset 122 first located in a first territory 104 crosses a boundary 124, 126, 128, 130 to enter into a second territory 106.

Such a pay-per-use model may cover costs associated with use of assets such as maintenance of the assets, costs associated with wear-and-tear of the assets, repair costs, fees associated with the assets, insurance related to the assets or use of the assets, and any other relevant or necessary costs. The Network Controller 100 may periodically update a set of rules 112 applicable to Network Participants 114, 116, 118, 120 associated with territories 104, 106, 108, 110 within a Region of Control 132, consistent with such a pay-per-use model depending on received input information regarding costs associated with use of the assets, such as but not limited to those listed in the preceding paragraph.

In the context of such a pay-per-use model, assets may remain in a territory 104, 106, 108, 110 associated with a Network Participant 114, 116, 118, 120 but may be owned by an entity distinct from the Network Participant 114, 116, 118, 120 associated with the territory 104, 106, 108, 110 in which the asset remains. Additionally, as an example, an asset in such a pay per use model may be used by, for example, a second Network Participant 116 distinct from, for example, a first Network Participant 114 associated with, for example, a first territory 104 in which the asset remains, if the asset moves into, for example, a second territory 106 associated with the second Network Participant 116. The second Network Participant 116 may then be obligated, as proscribed by a set of rules 112 defined by a Network Controller 100 consistent with a pay-per-use model, to pay fees associated with its use of the asset.

In a related embodiment of the present technology, an asset, rather than being defined as a physical asset, may be defined as a service. For instance, the assets may be an infrastructure that is useful in accomplishing a task, such as, for example, a private emergency medical services company or a self-contained AI program. With respect to a service asset, the ownership of the assets involved, such as the ownership of the cars, the ownership of intellectual property rights governing the infrastructure, the employer of the drivers and personnel, etc., may be of lesser importance than the ability of an entity to leverage the service to accomplish a task. The assets may be loaned to a Network Controller 100 for use in a Region of Control 132 in exchange for a fee or other agreement. The Network Controller 100 may then implement a set of rules 112 consistent with a pay-per-use model to allow Network Participants 114, 116, 118, 120 to use the assets. With respect to private emergency medical services, for example, a company owning such a service may loan the service to a Network Controller 100, which may be a governing body for a state, for example. Then, territories within that state, for example counties, may use the emergency medical services to provide transportation for their citizens consistent with a pay-per-use model. This may allow for efficient sharing of the service assets between counties. For instance, a first county may be located near water and experience a greater need for emergency medical services in summer months while a second county may be located in an arid area and may experience a greater need for emergency medical services in fall months. By sharing the assets between the two counties, neither county may need to maintain a full independent emergency medical services infrastructure of its own and thus such an arrangement may be more cost effective.

Additionally, in a shared service asset arrangement, assets may be the responsibility of the Network Participant of the territory in which the asset is used and then responsibility may pass to another network participant when the asset physically moves into another associated territory. In this way, costs associated with the service asset may be the responsibility of a given network participant only when an asset is actually in use in that associated territory. For instance, greater wear-and-tear costs may be associated with use of emergency medical services assets to respond to a fire emergency than a water emergency. If for example, a second county in a region of control experiences a greater number of fire emergencies, then wear-and-tear costs associated with those emergencies may be the responsibility of the second county while the service assets are in use in the second county. A first county may experience a greater number of water emergencies with lower associated wear-and-tear cost. The first county then, because most assets will not sustain high levels of wear while in use in the first county, will not be responsible for paying a larger share of maintenance costs. Such an arrangement is efficient in that it is specific to the differing needs of different territorial areas.

### Example Embodiment of Method for Managing Physical Assets Across Territorial Boundaries Wherein Assets are Provided to a Network for a Period

In an embodiment of the present technology, assets may be provided to the Network itself. The Network Controller may then define a set of rules for the assets based on a total fee for the assets that covers all relevant costs, such as loans, maintenance, wear and tear, and other associated costs, such as profits or labor requirements. Such a fee may then be distributed among network participants that would like to use the asset(s).

### Example Embodiment of Method for Managing Physical Assets Across Territorial Boundaries Between Two Territories

In an embodiment of the present technology, control, operator responsibility, and/or ownership of an asset may transfer from the owner of one territory to the owner of another territory when the asset physically moves from one territory to the other territory. In other words, the crossing of a physical boundary defining a territory is the trigger for a transfer of control of an asset.

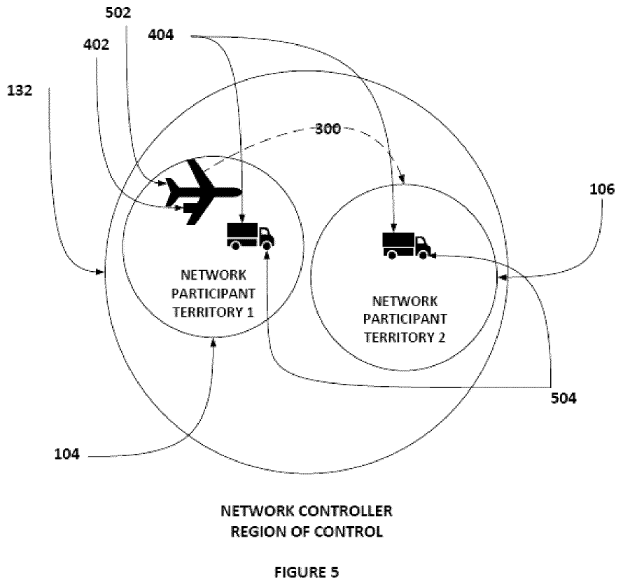

With reference now to FIG. 5 of the illustrative embodiments, there is shown an example of a region controlled by a network controller within which physical assets travel between territories, according to an embodiment of the present technology. A Region of Control 132 controlled by a Network Controller 100 is shown. The Region of Control 132 may contain two Network Participants'associated territories 104 and 106 over which the Network Participants maintain control. The Region of Control 132 may also include assets. These assets may be aircraft assets 402 and container assets 404. The Network 100 may also include Drayage trucks 504, aircraft 502 and other vehicles such as trains or ships. FIG. 5 shows a flight path the aircraft 502 may take to travel between a first territory 104 and a second territory 106.

As an aircraft 502 travels from a first territory 104 and leaves the first territory 104 and enters a second territory 106, control of the aircraft may pass from a first network participant associated with the first territory 104 to a second network participant associated with the second network territory 106. The transfer of control may be a transfer of operator responsibility. Alternatively, or simultaneously, the transfer of control may be a transfer of ownership of the aircraft, as least for the time the aircraft remains in the second territory. The transfer of control may also include a prorated sharing of the costs and revenues associated with the use, operation, and ownership of the aircraft. Therefore, the aircraft may remain under the control of the network participant associated with the first territory so long as the aircraft remains in the first territory, but, upon crossing a physical boundary and entering into a second territory, a network participant associated with the second territory assumes control of the aircraft.

The cost and revenue sharing among network participants, as discussed with respect to other embodiments, may be defined for the Network by the Network controller. The cost and revenue sharing may be based upon the amount of time an asset spends in a given territory. In order for the Network controller to update rules regarding cost and revenue sharing for an asset in a system where these costs and revenues are shared based on the amount of time an asset spends in a given location, information about the location of an asset, such as GPS coordinates, may be stored in a database and transmitted to the Network Controller. FIGS. 6 and 7 illustrate an example of a diagram of a network controller region database which is continually updated with inputs and provides outputs based on real time updates of inputs and an example of a network controller region database, for use in a method or system for managing physical assets across territorial boundaries, respectively.

As depicted by FIG. 5, a first customer located in a first territory 104 may want to ship a container of goods to a second customer located in a second territory 106. As proscribed by the set of rules 112 defined by the Network Controller 100, a first Network Participant 114 associated with and maintaining control over the first territory 104 may negotiate the costs associated with moving the container of goods with a second Network Participant 116 associated with a second territory 106. The first Network Participant may then provide a quote based upon those negotiations to the customer. Alternatively, cost sharing between Network Participants may be determined automatically by the Network Controller based on received and continuously updated information regarding the location of the container of goods with the Region of Control 132. A price quote for the customer may then be generated automatically. A customer cost may be finalized, at which point, a customer may pay a fee to the Network Participant maintaining control over the territory in which the customer is located and the fee paid may be automatically distributed, based on the set of rules 112 among all network participants involved, for example the first and second network participants 114 and 116.

In a related embodiment, an asset such as a public bus may be owned by a first network participant associated with a first territory, such as a city. The city may only require use of the bus for a period of six months and may not require use of the bus during the remainder of the year. If the city were to purchase its own bus for its exclusive use, such a bus may remain unused for a period of six months throughout the year. The city may, instead of retaining the bus for its exclusive user, enter into a network and agree to a set of rules, as defined by a network controller, to provide for the transfer of the bus to another network participant associated with another territory, during the periods when the first city does not require use of the bus.

In a related embodiment, an asset, such as a bus, may travel between two territories, such as two cities. In an existing system, a bus may travel to a second territory, such as a second city, using only infrastructure, such as road, belonging exclusively to the second city. A first territory, such as a first city, may not pay for use of the second territory's infrastructure even though the first city is involved in the transfer of the bus between territories. In an embodiment of the present technology, the territories may joint a Network or may together form a Network, and bind themselves to an agreement to share use, costs, fees, revenues, ownership, and other elements associated with the asset in a more equitable manner.

### Example Embodiment of System for Managing Physical Assets Across Territorial Boundaries

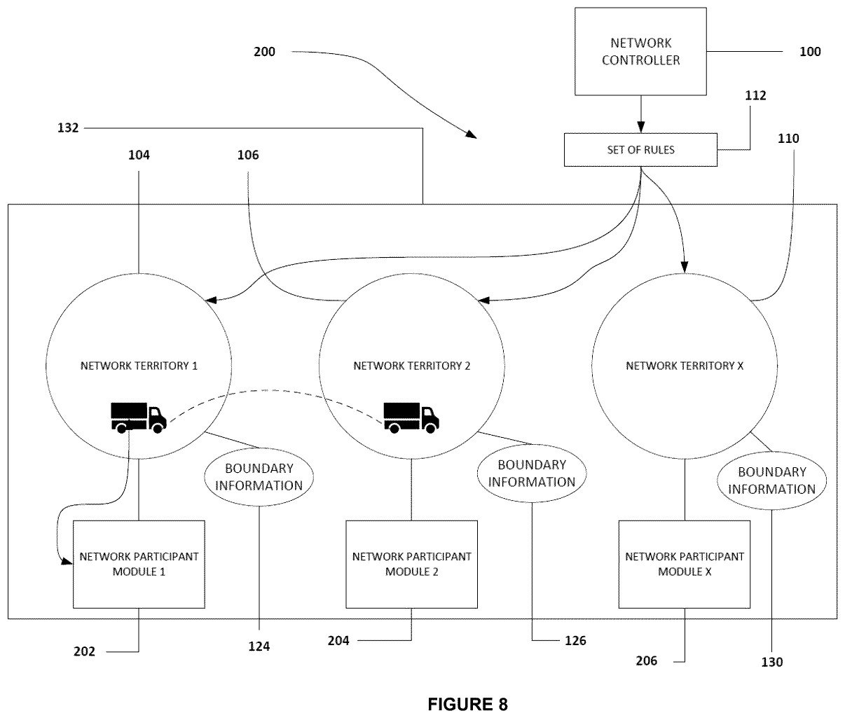

With reference now to FIG. 8 of the illustrative embodiments, there is shown a diagram showing an example of a system for managing physical assets across territorial boundaries, according to an embodiment of the present technology. A system 200 may include a physical asset 122 which may be configured to move within a Region of Control 132 which includes a plurality of territories 104, 106, 110. Each of the plurality of territories may have associated boundary information 124, 126, 130. A plurality of network participant modules 202, 204, 206 may be associated with each of the plurality of territories 104, 106, 110. The physical asset may be in operative communication with a first network participant module 202 which may be associated with a first territory 104 in which the physical asset 122 is located. Control of the physical asset 122 may pass from a first network participant module 104 to a second network participant module 106 pursuant to a set of rules 112 for the system 200 as defined by the network controller 100 wherein the transfer of control is triggered when the physical asset 122 crosses the boundary 126 associated with the second territory 106.

In a related embodiment, a physical asset 122 in the system 200 may be in operative communication with a second participant module 204 and may no longer be in operative communication with a first participant module 202 after control of the physical asset 122 is passed from the first network participant module 202 to the second network participant module 204 pursuant to the set of rules 112 defined for the system 200.

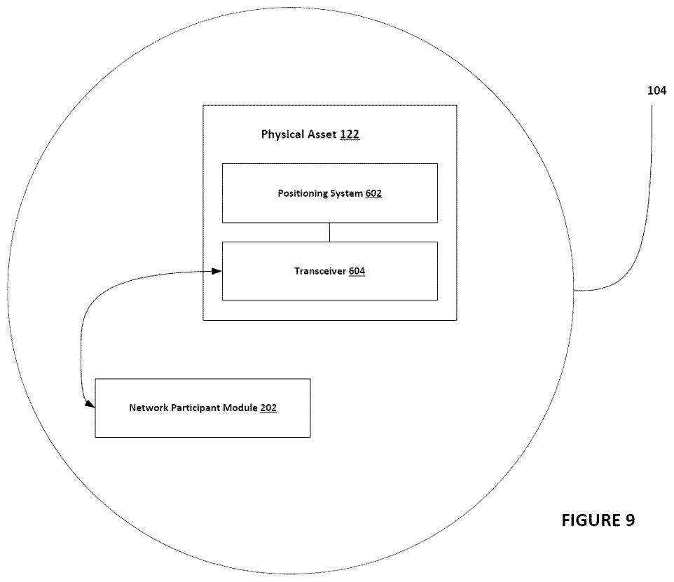

With reference now to FIG. 9 of the illustrative embodiments, there is shown a diagram showing an example of a physical asset, according to an embodiment of the present invention. A physical asset 122 may comprise a positioning system 602 and a transceiver 604. The transceiver 604 may be configured to be in operative communication with a first network participant module 202 when the physical asset 122 is located in a first territory 104 associated with a first network participant module 202. Similarly the transceiver 604 may be configured to be in operative communication with a second network participant module 204 when the physical asset 122 is located in a second territory 106 associated with the second network participant module 204.

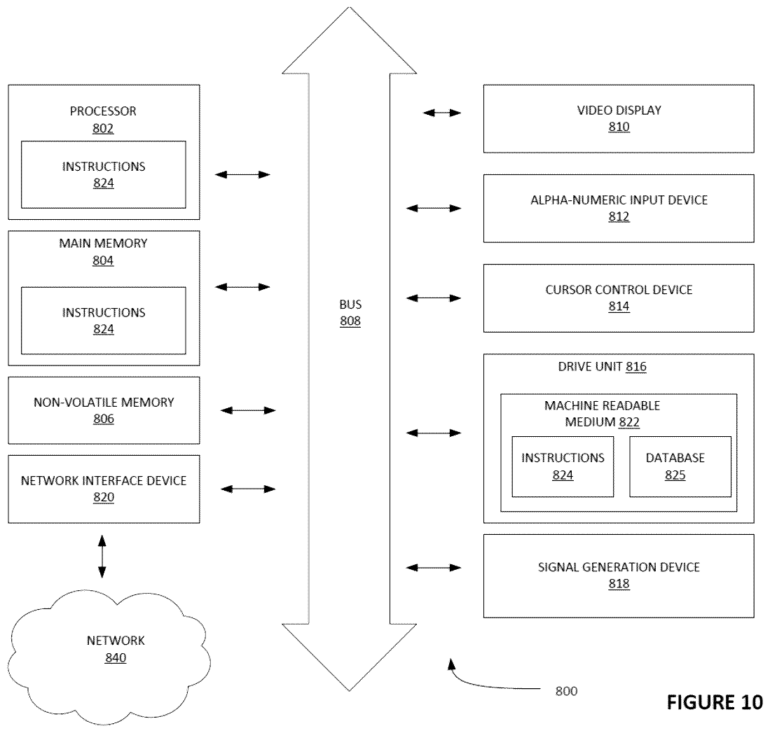

FIG. 10 illustrates an example machine 800 within which a set of instructions for causing the machine to perform one or more of the embodiments described herein can be executed, in accordance with an embodiment of the present disclosure. The embodiments can relate to one or more systems, methods, or computer readable media. The machine may be connected (e.g., networked) to other machines. In a networked deployment, the machine may operate in the capacity of a server or a client machine in a client-server network environment, or as a peer machine in a peer-to-peer (or distributed) network environment.

The machine 800 includes a processor 802 (e.g., a central processing unit (CPU), a graphics processing unit (GPU), or both), a main memory 804, and a nonvolatile memory 806 (e.g., volatile RAM and non-volatile RAM), which communicate with each other via a bus 808. The processor 802 can be implemented in any suitable form, such as a parallel processing system. In some cases, the example machine 800 can correspond to, include, or be included within a computing device or system. For example, in some embodiments, the machine 800 can be a desktop computer, a laptop computer, personal digital assistant (PDA), an appliance, a wearable device, a camera, a tablet, or a mobile phone, etc. In one embodiment, the machine 800 also includes a video display 810, an alphanumeric input device 812 (e.g., a keyboard), a cursor control device 814 (e.g., a mouse), a drive unit 816, a signal generation device 818 (e.g., a speaker) and a network interface device 820.

In one embodiment, the video display 810 includes a touch sensitive screen for user input. In one embodiment, the touch sensitive screen is used instead of a keyboard and mouse. The disk drive unit 816 includes a machine-readable medium 822 on which is stored one or more sets of instructions 824 (e.g., software) embodying any one or more of the methodologies or functions described herein. The instructions 824 can also reside, completely or at least partially, within the main memory 804 and/or within the processor 802 during execution thereof by the computer system 800. The instructions 824 can further be transmitted or received over a network 840 via the network interface device 820. In some embodiments, the machine-readable medium 822 also includes a database 825.

Volatile RAM may be implemented as dynamic RAM (DRAM), which requires power continually in order to refresh or maintain the data in the memory. Nonvolatile memory is typically a magnetic hard drive, a magnetic optical drive, an optical drive (e.g., a DVD RAM), or other type of memory system that maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals. The term “storage module”as used herein may be implemented using a machine-readable medium.

In general, the routines executed to implement the embodiments of the present disclosure can be implemented as part of an operating system or a specific application, component, program, object, module or sequence of instructions referred to as “programs” or “applications”. For example, one or more programs or applications can be used to execute specific processes described herein. The programs or applications typically comprise one or more instructions set at various times in various memory and storage devices in the machine and that, when read and executed by one or more processors, cause the machine to perform operations to execute elements involving the various aspects of the embodiments described herein.

The executable routines and data may be stored in various places, including, for example, ROM, volatile RAM, non-volatile memory, and/or cache. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of machines, those skilled in the art will appreciate that the various embodiments are capable of being distributed as a program product in a variety of forms, and that the embodiments described herein apply equally regardless of the particular type of machine-or computer-readable media used to actually effect the distribution. Examples of machine readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

The example embodiments discussed herein may confer several advantages over existing systems. These advantage include but are not limited to efficient cost sharing related to the use, costs, and revenues of a moving asset, promoting locale expertise within a territory as opposed to relying on the expertise beyond a local territory because the local territory lacks access to useful assets, as well as efficient use of assets and thus reduced storage costs and reduced costs associated with sourcing duplicative or excess assets.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

1. A method for managing control of assets moving across a region of control, the method comprising the steps of:
defining, by a network controller system, a region of control including a plurality of territories, each of the plurality of territories having a boundary and being associated with a respective network participant;
storing, by the network controller system, a set of rules for each of the plurality of territories;
controlling, by a first network participant module, an asset moving within the first territory according to a first set of rules, the first network participant being associated with the first territory;
moving, under control of the first network participant module, the asset within the first territory and then across a first boundary of the first territory into a second territory of the plurality of territories;
triggering transfer, from the first network participant module to a second network participant module associated with the second territory, control of the asset upon the asset crossing the boundary into the second territory; and
controlling, by the second network participant module, the asset moving within the second territory according to a second set of rules.

2. The method of claim 1, wherein the plurality of territories comprises one or more of the following: cities, counties, states, countries, economic exclusive zones, terrestrial regions, and extraterrestrial regions.

3. The method of claim 1, wherein the set of rules comprises one or more of the following: communication protocols, fee protocols, control protocols, and maintenance protocols.

4. The method of claim 1, wherein the set of rules comprises a protocol for sharing of costs and revenues between the plurality of network participants based upon amounts of time during which the asset is located within each of the plurality of territories.

5. (canceled)

6. The method of claim 1, wherein at least one network participant module is associated with a plurality of territories.

7. The method of claim 1, wherein the asset is selected from the group consisting of: an aircraft, bus, truck, drone, firetruck, police cruiser, ship, snowplow, and train.

8. The method of claim 1, wherein the asset is fully or partially autonomous.

9. The method of claim 1, wherein transferring control of the asset comprises transferring full or partial ownership of the asset.

10. The method of claim 1, wherein transferring control of the asset comprises one or more of the following: transferring a lease for the asset, transferring a pay-per-use contract for the asset, transferring payment responsibility for the asset, and transferring revenue-sharing payments.

11. The method of claim 10, wherein:
wherein transferring control of the asset comprises transferring a pay-per-use contract for the asset; and
the pay-per-use contact covers one or more of the following: insurance costs, maintenance costs, repair costs, and wear-and-tear.

12. The method of claim 1, further comprising the step of distributing revenues for use of the asset between a first entity associated with the first territory and a second entity associated with the second territory pursuant to each of the sets of rules.

13. The method of claim 12, wherein the step of distributing revenues for use of the asset takes into account costs for one or more of the following: fuel use, insurance for the asset, labor needed to operate the asset, loan costs for the asset, maintenance of the asset, and wear and tear of the asset.

14. The method of claim 1, further comprising the step of prorating fees for use of the asset between a first entity associated with the first territory and a second entity associated with the second territory according to each of the sets of rules;
wherein the fees are prorated based upon a first time period that the asset is within the first territory and a second time period that the asset is within the second territory.

15. The method of claim 1, further comprising the steps of:
subdividing the first territory into a plurality of sub-territories, each of the plurality of sub-territories having a territorial sub-boundary and
associating each of a plurality of network sub-participants with each of the plurality of sub-territories.

16. The method of claim 1, further comprising the steps of:
moving, under control of the second network participant, the asset within the second territor, and then back across the first boundary; and
transferring, by the second one network participant, control of the asset back to the first network participant when the asset moves across the first boundary into the first territory.

17. (canceled)

18. A system for managing control of assets moving across a plurality of territories of a region of control, each of the plurality of territories having a boundary, the system comprising:
a plurality of network participant modules, each network participant module associated with a territory, each network participant module in operative communication with the asset while the asset is located within the territory associated with it, a first network participant module configured to take control of the asset moving within a first territory until it crosses a first boundary to a second territory, a second network participant module configured to take control of the asset once the asset crosses the first boundary into the second territory.

19. The system of claim 18, wherein the first network participant module loses operative communication with the asset once the second network participant module takes control of the asset.

20. The system of claim 18, wherein the asset comprises:
a positioning system in operative communication with the first network participant module when the asset is in the first territory and in operative communication with the second network participant module when the asset is in the second territory.
